(19) United States
(12) Patent Application Publication
(10) Pub. No.: US 2025/0381677 A1
(43) Pub. Date: Dec. 18, 2025

(54) AUTOMATED TORQUE DRIVER SOLUTION

(71) Applicant: Applied Materials, Inc., Santa Clara, CA (US)

(72) Inventors: Spencer Gregory Carson, Georgetown, TX (US); Valerie Romero Foohey, Austin, TX (US); Atef Bayoumi, Austin, TX (US); James Dohrman, Pflugerville, TX (US); Ronald Dizon Bustos, Cedar Park, TX (US); Mariel Garcia, Austin, TX (US); Abdul-Hakim Demba Fofana, Buda, TX (US)

(73) Assignee: Applied Materials, Inc., Santa Clara, CA (US)

(21) Appl. No.: 18/747,307

(22) Filed: Jun. 18, 2024

(51) Int. Cl. B25J 11/00; B25J 9/16; B25J 13/08

(52) U.S. Cl. CPC B25J 11/005; B25J 9/161; B25J 9/1661; B25J 13/085

(57) ABSTRACT

A method may include receiving, by a computing system, a torque plan indicating a fastener pattern. The method may include determining, by the computing system and based at least in part on the torque plan, a respective position of each of a plurality of fasteners of the semiconductor manufacturing component. The method may include determining, by the computing system and based at least in part on the torque plan, a predetermined torque associated with each of the plurality of fasteners. The method may include causing, by the computing system, a first robotic arm to translate such that a bit tip of a first driver engages with one or more fasteners of the plurality of fasteners. The method may include causing, by the computing system, the first driver to rotate a bit of the first driver such that a fastener of the plurality of fasteners is tightened to a predetermined torque.

### TECHNICAL FIELD

The present technology relates to semiconductor processes and equipment. More specifically, the present technology relates to substrate processing systems and components.

### BACKGROUND

One of the most time-consuming and high-precision tasks in the semiconductor manufacturing is a torque process for securing components, such as for fastening flow control devices to other components of a gas panel or other semiconductor processing system. Each component may require precise torque in order to prevent leaks and/or damage to the component. For example, if a fastener of a flow control device is under-torqued, a seal between the flow control device and other component of the gas panel may be under-compressed, which may lead to leaks. If the seal is over-torqued, the seal may be damaged and may leak. If the fasteners of the flow control device are unevenly torqued, the seal may be unevenly compressed, which may cause leaks. In some torquing operations, a total number of precise torque passes may number in the thousands to tens of thousands. The volume of torque passes required per semiconductor manufacturing component creates a high risk for leaks which are both common and costly.

### BRIEF SUMMARY

A system for torquing fasteners of a semiconductor manufacturing component may include a first driver may include a bit and a bit tip. The system may include a first toolhead connected to the bit of the first driver. The system may include a first robotic arm connected to the first toolhead and configured to translate the first toolhead along an x-axis, a y-axis, and a z-axis. The system may include one or more processors and a computer-readable medium including instructions that, when executed by the one or more processors, cause the system to perform operations. According to the operations, the system may receive a torque plan indicating a fastener pattern associated with the semiconductor manufacturing component. The system may determine, based at least in part on the torque plan, a respective position of each of a plurality of fasteners of the semiconductor manufacturing component. The system may determine, based at least in part on the torque plan, a respective torque associated with each of the plurality of fasteners. The system may cause the robotic arm to translate such that the bit tip of the first driver iteratively engages with a fastener of the plurality of fasteners. The system may cause the first driver to rotate the bit of the first driver such that the fastener of the plurality of fasteners is tightened to the respective torque indicated by the torque plan.

In some embodiments, the toolhead may be connected to a second driver and may be configured to move the second driver independently of the first driver. The second driver, the second toolhead, and the second robotic arm may be independently moveable. The system may also include one or more controllers, configured to receive control signals from the one or more processors and cause the first and second robotic arms, the first and second toolheads, and the first and second drivers to perform one or more torquing operations. The first driver and the second driver may tighten respective fasteners of the plurality of fasteners such that the respective torque for the fastener engaged by the first driver and the fastener engaged by the second driver is reached simultaneously. The bit tip of the first driver may include a rounded portion and a pattern corresponding to at least a portion of the fastener. The semiconductor manufacturing device may include a gas panel. The first robotic arm may be configured to rotate the toolhead in one or more directions.

A method may include receiving, by a computing system, a torque plan indicating a fastener pattern associated with a semiconductor manufacturing component. The method may include determining, by the computing system and based at least in part on the torque plan, a respective position of each of a plurality of fasteners of the semiconductor manufacturing component. The method may include determining, by the computing system and based at least in part on the torque plan, a predetermined torque associated with each of the plurality of fasteners. The method may include causing, by the computing system, a first robotic arm to translate such that a bit tip of a first driver engages with one or more fasteners of the plurality of fasteners. The method may include causing, by the computing system, the first driver to rotate a bit of the first driver such that a fastener of the plurality of fasteners is tightened to a predetermined torque.

In some embodiments, the method may include determining, by the computing system, an actual torque of each of the one or more fasteners. The method may include determining, by the computing system, whether the actual torque is different than the predetermined torque. In response to determining that the actual torque is different than the predetermined torque, The method may include generating, by the computing system, an output for display indicating the actual torque.

In some embodiments, the method may include generating, by the computing system, a build plan, the build plan may include a record of each fastener and an associated actual torque, the record updated as the plurality of fasteners are tightened. The method may include determining, by the computing system, a position of the semiconductor manufacturing component. The method may include causing, by the computing system, the first driver to be positioned in an initial position according to the torque plan. The computing system may include one or more controllers configured to receive control signals from the computing system and cause the robotic arm and/or the first driver to perform torquing operations. The method may include causing, by the system, a second robotic arm to translate such that a bit tip of a second driver engages a second fastener of the plurality of fasteners. The method may include causing, by the system, the second driver to rotate a bit of the second driver such that the second fastener of the plurality of fasteners is tightened to the predetermined torque. The first driver and the second driver may tighten respective fasteners of the plurality of fasteners such that the predetermined torque is reached simultaneously.

A non-transitory computer-readable medium may include instructions that, when executed by one or more processors, cause the one or more processors to perform operations. The operations may include receiving, by a computing system, a torque plan indicating a fastener pattern associated with a semiconductor manufacturing component. The operations may include determining, by the computing system and based at least in part on the torque plan, a respective position of each of a plurality of fasteners of the semiconductor manufacturing component. The operations may include determining, by the computing system and based at least in part on the torque plan, a predetermined torque associated with each of the plurality of fasteners. The operations may include causing, by the computing system, a first robotic arm to translate such that a bit tip of a first driver engages with one or more fasteners of the plurality of fasteners. The operations may include causing, by the computing system, the first driver to rotate a bit of the first driver such that a fastener of the plurality of fasteners is tightened to a predetermined torque.

In some embodiments, the torque plan may be displayed in a user interface during operation of the computing system. The user interface is configured to accept user input to modify the torque plan during operation. The computing system may cause a plurality of robotic arms, a plurality of toolheads, and a plurality of drivers to execute the torque plan. Each of the plurality of fasteners may be tightened such that a seal of the semiconductor manufacturing component is uniformly compressed.

### BRIEF DESCRIPTION OF THE DRAWINGS

FIG. 1A illustrates a system for torquing fasteners for a semiconductor manufacturing component, according to certain embodiments.

FIG. 1B illustrates a system with a portion of a gas panel with a flow control device and a driver, according to certain embodiments.

FIG. 1C illustrates a system including a manufacturing chamber, according to certain embodiments.

FIG. 2 illustrates a torque plan, according to certain embodiments.

FIG. 3 illustrates a user interface for controlling and monitoring a torquing system, according to certain embodiments.

FIG. 4 illustrates a flowchart of a method for torquing fasteners of a semiconductor manufacturing component, according to certain embodiments.

FIG. 5 is a schematic diagram illustrating an example of computer system.

### DETAILED DESCRIPTION

Gases (such as plasma precursors, purge gases, cleaning gases, and the like) are frequently used in semiconductor manufacturing to perform various steps in forming semiconductor devices and/or for performing chamber maintenance. For example, the gases may be used to stabilize a processing chamber, as a precursor for a deposition process, an etchant, and/or used for any other such purpose in semiconductor manufacturing. The gases may be provided via a gas panel configured to precisely control the amount of gas flowing into the processing chamber. The control must be precise not only to control reactions within the processing chamber, but also to make efficient use of the gases. The presence of leaks may make it difficult to precisely control flow parameters (such as pressure and/or flow rate) of gases from the gas panel to one or more processing chambers. Control of the gases is not limited to just the processing chamber, however. As the gases may be relatively rare and expensive, losses of the gases must be minimized at all steps, including the manufacturing of components such as the gas panel. Additionally, some of the gases flowed through the gas panel may be toxic, which may make leaks dangerous.

A gas panel may include a plurality of flow control devices (e.g., valves, mass flow controllers, etc.) that control the flow and mixing of one or more gases through the gas panel and to one or more processing chambers. Each of the flow control devices may be configured to be secured to other components of the gas panel (such as gas blocks) using one or more fasteners during the manufacture of the gas panel. A seal may be disposed between each flow control device and the gas panel and may assist in minimizing gas losses during the manufacture and operation of the gas panel and otherwise. In order to increase the effectiveness of the seals, the fasteners may be tightened to a predetermined torque, compressing the seal. An issue, however, may be that as the fasteners are tightened the seal compresses unevenly, which may lead to leaks.

For example, a flow control device may be attached to the gas panel via four or other number of fasteners. As each fastener is tightened to the predetermined torque, a portion of the seal proximate the fastener being tightened may compress more than other portions of the same seal. This may lead to the seal being unevenly compressed and/or damaged permanently, increasing the likelihood of gas loss via one or more leaks. To address this, the fasteners may be tightened in an iterative pattern, such that each of the fasteners is tightened slightly in a particular order until all fasteners of the flow control device reach the predetermined torque. Thus, while portions of the seal may be compressed unevenly, the difference in compression is minimized as each iteration of the pattern compresses a portion the seal slightly more than the other portions.

This solution has issues as well, however. A gas panel may include any number of flow control devices. Each flow control device may be attached to the gas panel by any number of fasteners. The gas panel may therefore include hundreds of fasteners. Manually tightening (e.g., using a handheld torque driver) each fastener in an iterative pattern as done in prior systems may therefore take a large amount of time. Furthermore, due to the large number of fasteners, the likelihood of may be increased. For example, the likelihood that one or more fasteners do not reach the predetermined torque, are over-torqued, are unevenly torqued, etc. may be increased. An incorrectly torqued fastener may lead to the loss of gas via one or more leaks from the seal of a corresponding flow control device, and/or the failure of the gas panel. Therefore, improved systems and methods of torquing fasteners for semiconductor manufacturing components are needed to improve efficiency in the time needed to produce the semiconductor manufacturing components and in minimizing gas losses.

One solution may be to automatically torque multiple fasteners simultaneously in order to provide more even compression to seals between flow control devices and a gas panel (and/or any other semiconductor manufacturing component). A number of robotic arms (e.g., 1, 2, 3, etc.) may be connected to a respective toolhead. Each respective toolhead may include any number of drivers, each with a bit. The robotic arms and/or the respective toolheads may be configured to translate and/or rotate in any number of directions in order to mate the respective bits with a head of a fastener. The toolheads may then be configured to rotate the drivers in order to simultaneously and/or iteratively torque fasteners attaching the flow control devices to the gas panel. A computing system may be configured to control the operation of the various components of the system (e.g., the robotic arms, toolheads, etc.).

A gas panel may then be provided such that the drivers may reach some or all of the fasteners of the gas panel. A torque plan may then be provided to the computing system. The torque plan may indicate the location of each fastener of the gas panel and a predetermined torque for each fastener. The torque plan may also indicate an order that each fastener is to be torqued. For example, the gas panel may include 3 flow control devices, each with four fasteners. The torque plan may indicate that flow control device 2 is to be torqued first, then flow control device 1, then finally flow control device 3. The computing system may then identify a position of the gas panel and move one or more of the robotic arms, toolheads, and/or drivers into an initial position, where bits of the drivers are engaged with a corresponding head of a respective fastener about flow control device 2. The computing system may then cause the toolheads to rotate the drivers such that each respective fastener is torqued to the appropriate predetermined torque. As each of the respective fasteners may be torqued simultaneously, a seal beneath flow control device 2 may be compressed uniformly, reducing the chance of damage to the seal. After the respective fasteners about flow control device 2 are torqued, the computing system may cause the robotic arms, drivers, etc. to tighten fasteners about flow control devices 1 and 3 in a similar fashion. The result may be that all seals are compressed evenly and more quickly than by using conventional methods (e.g., manually via an iterative pattern).

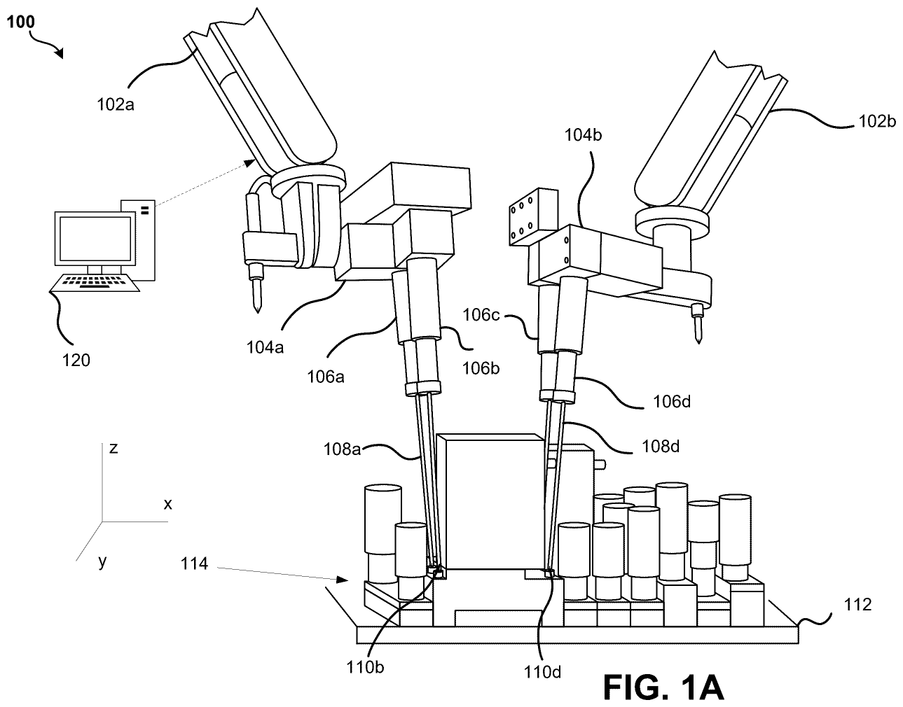

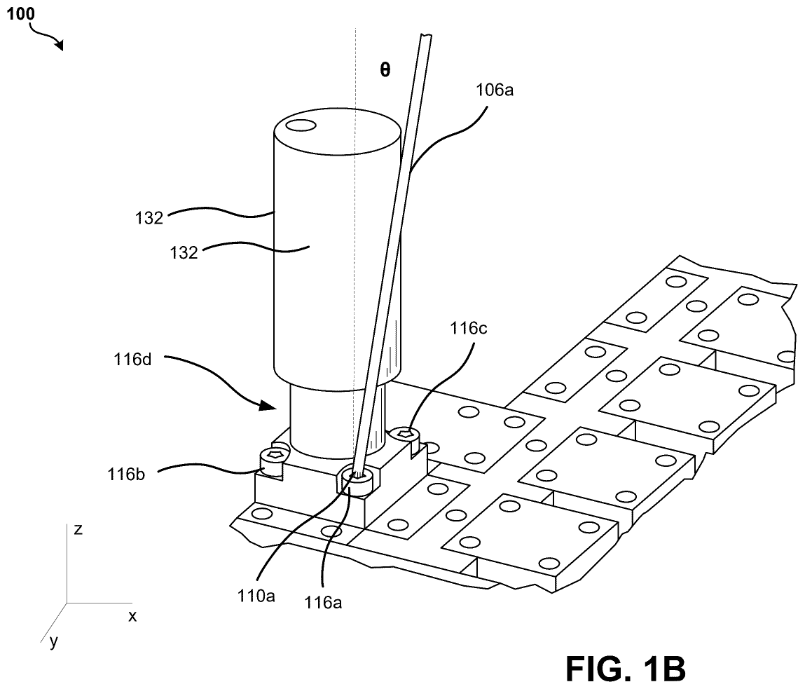

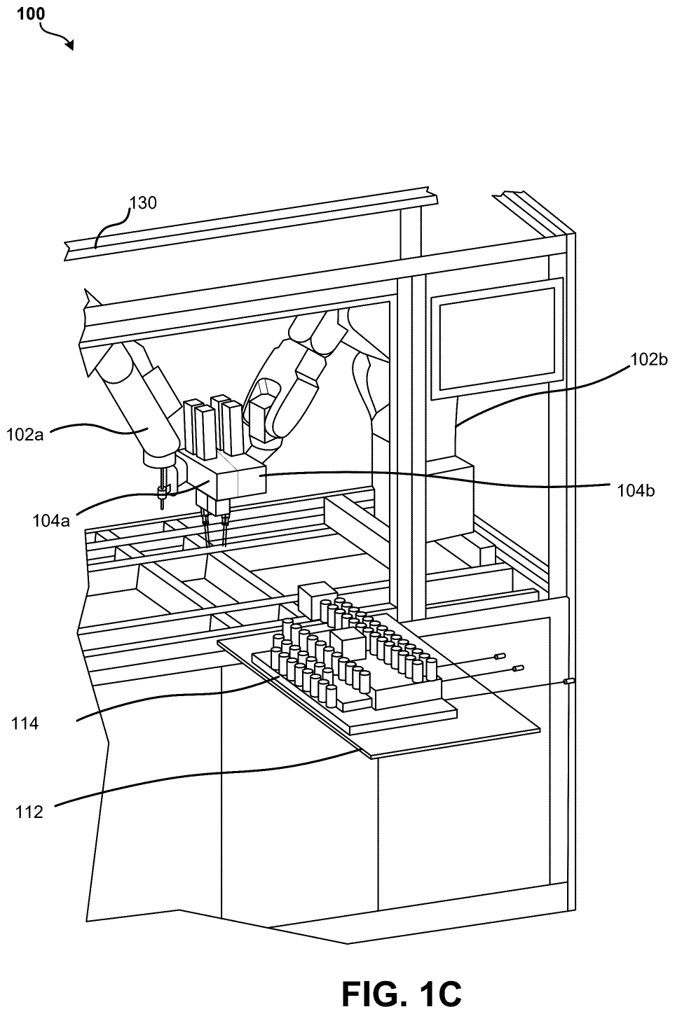

FIGS. 1A-C illustrate a system 100 for torquing fasteners for a semiconductor manufacturing component, according to certain embodiments. The system 100 may include robotic arms 102a-b, toolheads 104a-b, and drivers 106a-d. The drivers 106a-d may include a bit 108a-d and a bit tip 110a-d. The system 100 may also include a platform 112, configured to support a gas panel 114 in a particular position. The system 100 may also include a computing system 120, configured to generate and transmit control signals to various other components of the system 100. Although FIG. 1A shows two robotic arms 102a-b, there may be any number of robotic arms (e.g., 1, 3, 4, etc.). Similarly, any number of toolheads and/or drivers may be included in the system 100.

The robotic arms 102a-b may be connected to and/or include one or more motors configured to translate the toolheads 104a-d and/or the drivers 106a-d in an x-direction, a y-direction, and/or a z-direction. The one or more motors may also be configured to rotate the toolheads 104a-d about an axis (e.g., the x-axis, the y-axis, and/or the z-axis). Furthermore, each of the robotic arms 102a-d may be configured to move independently of the other. For example, in a given operation, the robotic arm 102a may translate along the x-axis (e.g., out of the page), and down the z-axis (e.g., towards the gas panel 114). During the same operation, the robotic arm 102b may translate right along the y-axis, while also down the z-axis. In other words, the motion of each of the robotic arms 102a-b may be unrelated to the motion of the other robotic arm.

The toolheads 104a-b may be connected to the robotic arms 102a-b, respectively. The toolheads 104a-b may be connected to and/or include motors that can rotate the toolheads 104a-b about a longitudinal radius of the robotics arms 102a-b. The one or more motors may also translate the toolheads 104a-b along the respective robotic arm 102a-b. The drivers 106a-d may also include motors configured to rotate the bits 108a-d at one or more speeds along a longitudinal axis of each of the bits 108a-d. The bits 108a-d may be rotated at a speed of about 200, about 300 rpm, 400 rpm, 500 rpm, 600 rpm, 700 rpm, 800 rpm, 900 rpm, and/or greater than 1000 rpm. In a particular operation, some or all of the bits 108a-d may be rotated at the same speed, or each bit 108a-d may be rotated at a different speed. Each driver 106a-d may include a torque sensor that may determine a torque exhibited by its associated bit 108a-d. When the measured torque reaches a predetermined torque, the driver 106a-d may stop rotating the associated bit 108a-d. The measured torque (or “actual torque”) may then be detected by the computing system 120 and recorded.

The toolheads 104a-b may also be configured to translate such that the drivers attached to the toolheads 104a-b can become closer or farther away from one another. For example, the toolheads 104a may be connected to the drivers 106a-b. In a given operation, the toolhead 104a may “open” such that a distance between the driver 106a and the driver 106b increases. To accomplish this, the toolhead 104a may move one or both of the drivers 106a-b. In other words, the toolheads 104a-b may cause one or all of the connected drivers 106a-d to move independently.

Similarly, the toolheads 104a-b may be configured to rotate the drivers 106a-d independently relative to the z axis. For example, due to tolerances and/or available space on the gas panel 114, each of the drivers 106a-d may be rotated (or angled) to engage a respective fastener of the gas panel 114 at a particular angle, as measured from vertical. For example, the drivers 106a-d may engage with the respective fasteners at an angle in a range of 0.5° to 10°, inclusive. For example, the angle(s) may about 5°, about 5.5°, about 6°, about 6.5°, about 7° and/or any combination thereof. Each driver 106a-d may be angled at a different angle, or some or all of the drivers 106a-d may be angled at the same angle.

The bit tips 110a-d may include any pattern or design corresponding to a head of a fastener. For example, the bit tips 110a-d may include a cross pattern (e.g., a Philip's head), flat pattern, a star pattern (e.g., a Torx pattern), a hex pattern, etc. In some embodiments, some or all the bit tips 110a-d may include a patterned portion and a rounded portion. The patterned portion may be configured to correspond to a portion of a head of a fastener. The rounded portion may be configured to allow the bit tip 110a-d to engage with the head of the fastener when angled.

The platform 112 may include one or more markings or other indicators corresponding to a position of the gas panel 114. The gas panel 114 may be aligned with the markings on the platform 112 in order to provide a standard position of the gas panel during a torquing operation, such as to calibrate a coordinate system used to position the drivers 106a-d and bits 108a-d into alignment and engagement with heads of the various fasteners of the gas panel 114. If the gas panel 114 were placed in a non-standard position, locations provided by the computing system 120 may not necessarily correspond to the locations of fasteners on the gas panel 114. The platform 112 may include other marking corresponding to other types of gas panels and/or components. For example, the gas panel 114 may be one type of semiconductor manufacturing component capable of being torqued by the system 100. Another type of semiconductor manufacturing component (e.g., another type of gas panel and/or another component) may be of a different size and/or shape. Thus, the other markings on the platform 112 may correspond to the other type of semiconductor manufacturing component and provide a standard position for the other type of semiconductor manufacturing component.

The computing system 120 may be configured to receive data from an external source via a wireless connection, wired connection, disk, optical media, or other suitable medium. The computing system 120 may also be configured to execute a program and/or instructions included in the data in order to execute a torque plan. The torque plan may include a graphical or other representation of the gas panel 114, including coordinates of each fastener included (or to be included) on the gas panel 114. The coordinates may be relative to a specific point on the gas panel 114, such as a corner, a center, a specific feature, or any other suitable marker. The coordinates may include three dimensional coordinates for each fastener. For example, a first fastener (associated with a first flow control device, such as a valve, mass flow controller, or other flow control device) may have a position at coordinates of (1, 3, 2). A second fastener associated with the second flow control device may have a position at (2, 3, 2). One of ordinary skill in the art would recognize many different possibilities and configurations.

The torque plan may also include a predetermined torque for each fastener of the gas panel 114. In some embodiments, the fasteners associated with any particular flow control device may have equal predetermined torques. For example, the first fastener and second fastener may have predetermined torques of 10 in-lbs. A third fastener and a fourth fastener, being associated with a second flow control device, may have predetermined torques of 25 in-lbs. In other embodiments, the predetermined torques for all fasteners on the gas panel 114 may be the same (e.g., within a range of 2 in-lbs to 100 in-lbs, inclusive). In yet other embodiments, each fastener on the gas panel 114 may include an individual predetermined torque, independent of any other fastener or feature of the gas panel 114. In some embodiments, the torque plan may indicate a driver/bit angle that the robotic arms 102a-b and/or toolheads 104a-d must set the drivers 106a-d at to align the bits 108a-d with the fasteners without contacting the flow control devices. In some embodiments, the torque plan may include a 3D geometry of the gas panel 114, which may enable the computing system 120 to determine a proper driver/bit angle for avoiding contact with the flow control devices.

The computing system 120 may be configured to generate one or more control signals according to the torque plan. The computing system 120 may then transmit some or all of the control signals to one or more controllers associated with one or more of the robotic arms 102a-b, the toolheads 104a-b, and/or the drivers 106a-d. The controllers may be included in the computing system 120 or may be a separate computing device. In some embodiments, the controllers may be included in the robotic arms 102a-b, the toolheads 104a-b, and/or the drivers 106a-d. The control signals may cause some or all of the components of the system 100 to execute the torque plan, tightening each fastener of the gas panel 114 to the predetermined torque.

FIG. 1B illustrates a portion of the gas panel 114 with a flow control device 132 and the driver 106a, according to certain embodiments. The flow control device 132 may be attached to the gas panel 114 via fasteners 116a-d. The fastener 116d may be disposed behind the flow control device 132, not visible in FIG. 1C. The bit tip 110a may be engaged with some or all of a head of the fastener 116a. The driver 106a may engage with the fastener 116a at an angle θ, measured from a vertical axis. The angle θ may be within a range of 0.5° to 10°, inclusive. In some embodiments, the bit tip 110a may include a pattern such as a square, flat, a cross-shape (e.g., a Philip's head), a star shape, or any other suitable shape. The bit tip 110a may include the pattern on some or all of the bit tip 110a or may include a rounded portion to accommodate insertion of the bit tip 110a at a non-vertical angle (e.g., the angle θ).

Although only one driver 106a is shown, it should be understood that any or all of the drivers of the system 100 may be present, each engage with a corresponding fastener. For example, the driver 106b may engage with the fastener 116b, the driver 106c may engage with the fastener 116c, and the driver 106d may engage with the fastener 116d. By engaging and torquing the fasteners 116a-d simultaneously, a seal between the flow control device 132 and the gas panel 114 may be compressed simultaneously, reducing the risk of damage to the gas panel 114 and the risk of leaks.

FIG. 1C illustrates the system 100 including a manufacturing chamber 130, according to certain embodiments. The robotic arms 102a-b, the toolheads 104a-b, and the drivers 106a-d may be disposed within the manufacturing chamber 130. The manufacturing chamber 130 may be configured to accept the gas panel 114 by translating the platform 112 to the outside of the manufacturing chamber 130. The gas panel 114 may be placed on the platform 112 while the platform is outside of the manufacturing chamber 130. Thus, the gas panel 114 may be placed correctly in the standard position (e.g., using the markers) without risk of accidentally displacing the other components of the system 100.

Once the gas panel 114 is placed on the platform 112, the platform 112 may be translated into the manufacturing chamber 130. The manufacturing chamber 130 may be under vacuum. After the torque plan is executed, helium, argon, or any other inert gas may be flow through the gas panel 114. If a leak is present, a gas detector, such as a helium detector, may indicate the presence of helium or other gas and the leak may be repaired. For example, the interface of a particular flow control device may have a damaged seal and/or not be torqued properly leading to a leak. After the leak has been detected, the system 100 (and/or components thereof) may remove the particular flow control device such that a repair may be affected, such as by replacing the seal and/or recompressing the seal if undamaged.

By providing an automated fastener torquing system as described above, embodiments of the present invention may enable some or all fasteners for a given component (such as a flow control device) to be tightened simultaneously. The simultaneous tightening, along with consistent torque values of each fastener (such as measured by torque sensors) may ensure that the seals for each flow control device are uniformly compressed to a desired torque value. This may reduce the likelihood of seal failure. Additionally, the use of automated torquing devices may enable the many fasteners of a gas panel to be tightened accurately at much faster speeds than when done manually.

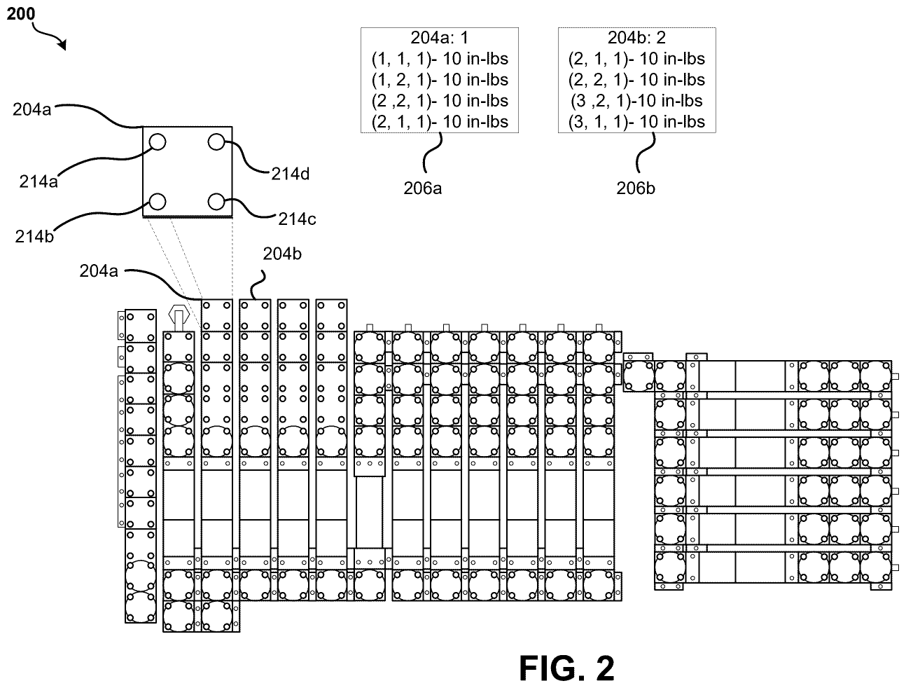

FIG. 2 illustrates a torque plan 200 for a semiconductor manufacturing component 202, according to certain embodiments. The torque plan 200 may include a graphical representation of the semiconductor manufacturing component 202. The semiconductor manufacturing component 202 may be similar to the gas panel 114 in FIGS. 1A-1C. As such, the semiconductor manufacturing component 202 may include a plurality of regions 204a-n that are configured to accept flow control devices. Each of the regions 204a-n may also include holes 214a-d configured to accept fasteners such as screws, bolts, or any other suitable fastener. Although only the regions 204a-b are labelled, it should be readily apparent that the semiconductor manufacturing component 202 may include any number of regions, with corresponding features (e.g., the holes 214a-d). While shown with four fasteners for each flow control device, it will be appreciated that one or more of the flow control devices may include fewer or greater fasteners in various embodiments. In some embodiments, a number of toolheads (e.g., toolheads 104a-d) and/or a number of drivers (e.g., drivers 106a-d) may match a greatest number of fasteners present on a single component, although other arrangements are possible in various embodiments.

In some embodiments, the torque plan 200 may include information regarding the 3-dimensional geometry of the semiconductor manufacturing component 202. For example, the torque plan 200 may include data indicating the location and size of each component (such as a flow control device) of the semiconductor manufacturing component 202. In a particular embodiment, the torque plan 200 may include computer aided drafting (CAD) files and/or data extrapolated from CAD files of the semiconductor manufacturing component 202. This information may enable a computing device (such as computing system 120) to determine a correct position and orientation (e.g., tilt angle) for each driver (e.g., driver 106a-d) necessary to engage each fastener without contacting any of the flow control devices or other components of the semiconductor manufacturing component 202. Additionally, or alternatively, the torque plan 200 itself may specify the correct position and orientation for each driver necessary to engage each fastener.

The torque plan 200 may additionally or alternatively include instruction sets 206a-b. Each of the instruction sets 206a-b may include a series of coordinates, predetermined torques, and an order to be performed. Each instruction set 206a-b may be associated with a particular region 204a-b. For example, the instruction set 206a may be associated with the region 204a. The instruction set 206a may indicate that the region 204a (and fasteners associated therewith) are to be torqued first. The instruction set 206a may also include coordinate sets for each of the holes 214a-d and a predetermined torque for each fastener at that location. For example, the hole 214a may correspond to the coordinates (1, 1, 1) and have a predetermined torque of 10 in-lbs. The hole 214b may correspond to the coordinates (1, 2, 1) and have a predetermined torque of 10 in-lbs. The hole 214c may correspond to the coordinates (2, 2, 1) and have a predetermined torque of 10 in-lbs. The hole 214d may correspond to the coordinates (2, 1, 1) and have a predetermined torque of 10 in-lbs.

Similarly, the instruction set 206b may include coordinates and predetermined torques for the region 204b. The torque plan 200 may include instruction sets for all n regions of the semiconductor manufacturing component 202 and corresponding holes and fasteners, each instruction set including an order to be performed. The computing system may then determine and provide control signals to various components of a torquing system (e.g., the system 100) to execute the torque plan 200. In some embodiments, the computing system may be configured to determine an order for tightening the various fasteners of the torque plan 200, such as by determining a most efficient tightening pattern.

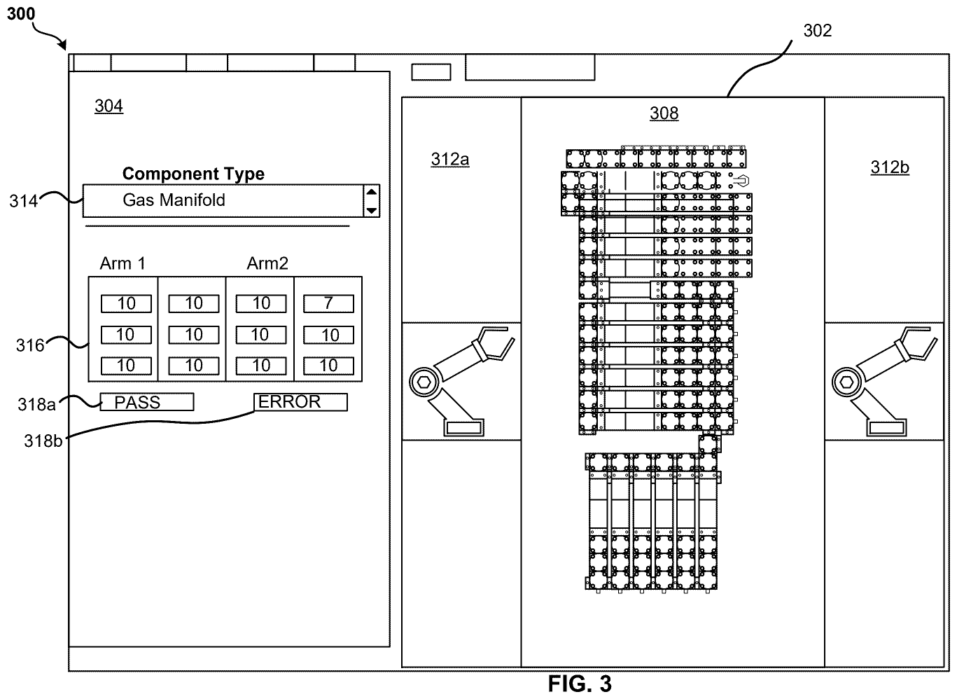

FIG. 3 illustrates a user interface 300 for controlling and monitoring a torquing system, according to certain embodiments. The user interface 300 may be displayed via a computing system such as the computing system 120 in FIG. 1. The user interface 300 may therefore provide a status of a semiconductor manufacturing component during a torquing operation. The user interface 300 may also provide elements for receiving user inputs such that a torque plan may be modified before and/or during the torquing operation.

The user interface 300 may include a status window 302 and a control window 304. The status window 302 may further include a component display 308 and system displays 312a-b. The component display 308 may include a graphical representation the semiconductor manufacturing component while in a manufacturing chamber (e.g., the manufacturing chamber 130). The graphical representation may be based at least in part on a torque plan (e.g., the torque plan 200 in FIG. 2). The graphical representation may include one or more user selectable elements. For example, a user may select a region corresponding to the region 204a in FIG. 2 via a mouse click, keystroke, stylus, or any other suitable input means. In response, information associated with the region 204a may be displayed (e.g., in the control window). In some embodiments, a tool tip or similar feature may be displayed by the user interface 300.

The system displays 312a-b may include representations and/or data associated with the torquing system (e.g., the system 100). As shown in FIG. 3, the system display 312a may show a representation of the robotic arm 102a. The system display 312a may include a status (e.g., operational, error, etc.), temperature, operational data (e.g., position, RPM, etc.) and other such information of the torquing system and/or a component thereof. For example, the user may wish to see information about the toolhead 104a. The user may provide an input via the user interface 300 indicating so. Then, the system display 312a may display information about the toolhead 104a. Similar features and operations may be performed by the user interface 300 (and/or the computing system) in the system display 312b. One of ordinary skill in the art would recognize many different possibilities of information that might be displayed in the component display 308 and/or the system displays 312a-b.

The control window 304 may include a component selector 314. The component selector 314 may include a drop-down menu containing a list of semiconductor manufacturing component that have a torque plan stored or available to the computing system. In some embodiments, the component selector 314 may be auto populated by the computing system upon detecting a component in the manufacturing chamber. As shown in FIG. 3, the semiconductor manufacturing component type may be a gas panel (e.g., the gas panel 114). This may correspond to the graphical representation in the component display 308.

The control window 304 may also include statuses of various operations during the torquing operation. For example, a status window 316 may include rows of predetermined torques and actual torques for various fasteners. As shown in FIG. 3, the status window 316 may show the predetermined torques for each of the robotic arms 102a-b in FIG. 1 for a particular region (e.g., the region 204a). The first row may indicate that arm 1 torqued three fasteners, each with an expected torque of 10 in-lbs. The second row may show that the actual torque for each fastener is 10 in-lbs. A notification window 318a may therefore indicate that the torquing operations is successful. The third row may indicate that arm 2 torqued three fasteners, each with an expected torque of 10 in-lbs. However, one of the fasteners may have only been torqued to 7 in-lbs (e.g., due to a failure of the torquing system, a piece of the semiconductor manufacturing component, etc.). Thus, a notification window 318b may indicate that the torquing operation failed.

It should be understood that the user interface 300 and components thereof are merely exemplary. The user interface 300 may include any number of windows, displays, etc. and display any type of information. The user interface 300 may also include a number of elements capable of accepting user inputs. The user interface 300 may allow for the torquing operation to be partially completed. For example, as each of the fasteners is tightened, a build plan may be generated to include a record of each fastener and the actual torque. As each fastener is tightened, the build plan may be updated. In some embodiments, a portion of the torque plan may not be completed (e.g., a component is unavailable to be assembled). The build plan may indicate that the portion of the torque plan has not been executed. At a later time, when the component is available to be assembled, the semiconductor manufacturing component may be placed in the torquing system again. Then, the build plan may indicate that only the portion of the torque plan is to be executed. The user interface may additionally or alternatively allow for user editing of the torque plan, and other such operations. One of ordinary skill in the art would recognize many different possibilities and configurations.

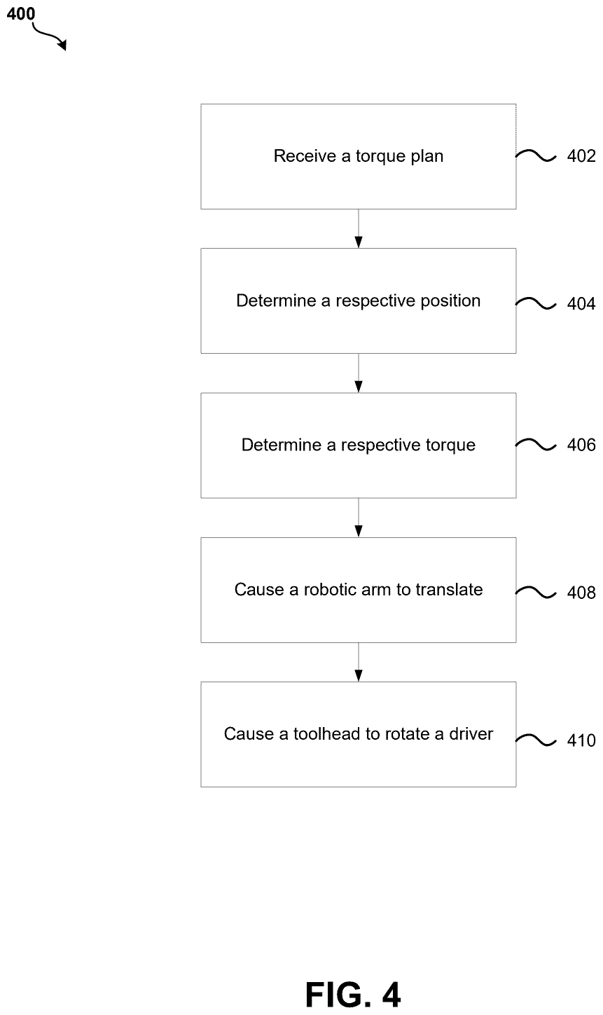

FIG. 4 illustrates a flowchart of a method 400 for torquing fasteners of a semiconductor manufacturing component, according to certain embodiments. The method 400 may be performed by some or all of the systems and devices described herein, such as the systems 100 described in FIGS. 1A-1C. The steps of the method 400 may be performed in a different order than is shown and described and/or may be combined with other steps. In some embodiments, some steps may be skipped altogether.

At 402, the method 400 may include receiving, by a computing system, a torque plan indicating a fastener pattern associated with a semiconductor manufacturing component. The computing system may be similar to the computing system 120 in FIG. 1A. The torque plan may be similar to the torque plan 200 and include a graphical representation of the semiconductor manufacturing component and/or one or more instruction sets. The semiconductor manufacturing component may include a gas panel (e.g., the gas panel 114) and/or any other such semiconductor manufacturing component.

In some embodiments, the computing system may cause some or all of the torque plan to be displayed in a user interface such as the user interface 300 in FIG. 3. The user interface may display information about the semiconductor manufacturing component and/or a torquing system such as the system 100. The user interface may permit a user to modify the torque plan and/or store information about the torque plan and/or semiconductor manufacturing component in a computer readable memory. Therefore, a torquing operation may be paused and continued at some later time. For example, as each of the fasteners is tightened, a build plan may be generated to include a record of each fastener and the actual torque. As each fastener is tightened, the build plan may be updated. In some embodiments, a portion of the torque plan may not be completed (e.g., a component is unavailable to be assembled). The build plan may indicate that the portion of the torque plan has not been executed. At a later time, when the component is available to be assembled, the semiconductor manufacturing component may be placed in the torquing system again. Then, the build plan may indicate that only the portion of the torque plan is to be executed.

At 404, the method 400 may include determining, by the computing system and based at least in part on the torque plan, a respective position of each of a plurality of fasteners of the semiconductor manufacturing component. The respective position may be represented by a coordinate set relative to a known (standard) position of the semiconductor manufacturing component. As shown in FIG. 2, the each of the plurality of fasteners (or corresponding holes in the semiconductor manufacturing component) may have a unique coordinate representation. Thus, the computing system may generate control signals directing the torquing system (or components thereof) to the appropriate location(s).

At step 406, the method 400 may include determining, by the computing system and based at least in part of the torque plan, a predetermined torque associated with each of the plurality of fasteners. In some embodiments, each of the plurality of fasteners may have equal predetermined torques. For example, a first fastener and a second fastener may have predetermined torques of 10 in-lbs. A third fastener and a fourth fastener may have predetermined torques of 25 in-lbs. In other embodiments, the predetermined torques for all fasteners of the semiconductor manufacturing component may be the same (e.g., within a range of 2 in-lbs to 100 in-lbs, inclusive). In yet other embodiments, each fastener may include an individual predetermined torque, independent of any other fastener or feature of the semiconductor manufacturing component.

At step 408, the method 400 may include causing, by the computing system, a robotic arm to translate such that a bit tip of a first driver iteratively engages with one or more fasteners of the plurality of fasteners. For example, each bit tip may engage with a different fastener on a single component. Then, at step 410, the method 400 may include causing, by the computing system, a toolhead to rotate a bit of the driver such that the one or more fasteners of the plurality of fasteners are tightened to a predetermined torque. According to the torque plan (and/or a corresponding control signal from the computing system), the robotic arm may be positioned above a first fastener such that the first driver (or a bit tip thereof) engages with the head of the first fastener. The computing system may then cause the driver to rotate, tightening the fastener until the predetermined torque is reached. Then, the robotic arm (and toolhead(s) and driver(s)) may move and tighten a second fastener of a different component. In this manner, all fasteners on the semiconductor manufacturing component may be tightened to their respective predetermined thresholds.

In some embodiments, the computing system may cause multiple robotic arms with multiple toolheads and/or multiple drivers in a torquing system to be positioned and tighten multiple fasteners simultaneously. For example, as described in FIG. 1, a torquing system may include two robotic arms, two toolheads, and four drivers, although other numbers of the various components are possible. The computing system may then determine a plurality of fasteners associated with a flow control device. The computing system may determine a position for each of the drivers such that each of the drivers engages with a respective fastener of the plurality of fasteners. The computing system may then cause each of the drivers to move to the respective position(s) by transmitting one or more control signals to one or more controllers (e.g., to move the robotic arms and/or toolheads). Then, the computing system may cause each of the drivers to tighten the respective fasteners to a predetermined torque simultaneously. A torque sensor of each driver may cause the driver(s) to stop upon reaching the predetermined torque by measuring the actual torque applied to the respective fastener. The actual torque may be received by the computing system and be recorded and/or displayed (e.g., by the UI 300).

Because all of the fasteners associated with the flow control device may be tightened simultaneously, a seal between the flow control device and the gas panel may be compressed uniformly. The uniform compression of the seal may prevent damage to the seal and/or leaks in the gas panel. Furthermore, because the torquing system is automated, the speed in which the fasteners may be tightened is significantly faster than conventional manual torquing techniques. Also, the actual torques may be more easily accessed and recorded, and more precise control of the actual torque may be achieved as compared to a manual torquing process.

In some embodiments, the method 400 may include determining, by the computing system, an actual torque of each of the one or more fasteners. For example, the actual torques may be determined by respective torque sensors of each of the drivers. The method 400 may include determining, by the computing system, whether the actual torque is different than the predetermined torque (e.g., by comparing the actual torque to the predetermined torque in the torque plan). In response to determining that the actual torque is different than the predetermined torque generating, by the computing system, and output for display indicating the actual torque, as is described in relation to FIG. 3.

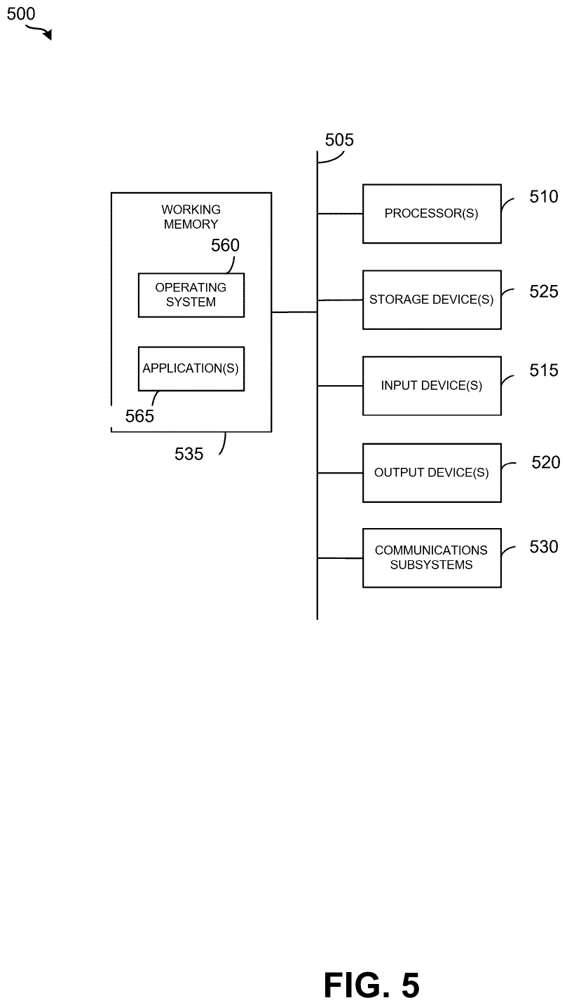

FIG. 5 is a schematic diagram illustrating an example of computer system 500. The computer system 500 is a simplified computer system that can be used to implement various embodiments described and illustrated herein, such as computing system 120. FIG. 5 provides a schematic illustration of one embodiment of a computer system 500 that can perform some or all of the steps of the methods and workflows provided by various embodiments. It should be noted that FIG. 5 is meant only to provide a generalized illustration of various components, any or all of which may be utilized as appropriate. FIG. 5, therefore, broadly illustrates how individual system elements may be implemented in a relatively separated or relatively more integrated manner.

The computer system 500 is shown including hardware elements that can be electrically coupled via a bus 505, or may otherwise be in communication, as appropriate. The hardware elements may include one or more processors 510, including without limitation one or more special-purpose processors such as digital signal processing chips, graphics acceleration processors, and/or the like; one or more input devices 515, which can include without limitation a mouse, a keyboard, a camera, and/or the like; and one or more output devices 520, which can include without limitation a display device, a printer, and/or the like.

The computer system 500 may further include and/or be in communication with one or more non-transitory storage devices 525, which can include, without limitation, local and/or network accessible storage, and/or can include, without limitation, a disk drive, a drive array, an optical storage device, a solid-state storage device, such as a random access memory (“RAM”), and/or a read-only memory (“ROM”), which can be programmable, flash-updateable, and/or the like. Such storage devices may be configured to implement any appropriate data stores, including without limitation, various file systems, database structures, and/or the like.

The computer system 500 might also include a communications subsystem 530, which can include without limitation a modem, a network card (wireless or wired), an infrared communication device, a wireless communication device, and/or a chipset such as a Bluetooth™ device, a 802.11 device, a Wi-Fi device, a Wi-Max device, cellular communication facilities, etc., and/or the like. The communications subsystem 530 may include one or more input and/or output communication interfaces to permit data to be exchanged with a network such as the network described below to name one example, other computer systems, television, and/or any other devices described herein. Depending on the desired functionality and/or other implementation concerns, a portable electronic device or similar device may communicate image and/or other information via the communications subsystem 530. In other embodiments, a portable electronic device, e.g., the first electronic device, may be incorporated into the computer system 500, e.g., an electronic device as an input device 515. In some embodiments, the computer system 500 will further include a working memory 535, which can include a RAM or ROM device, as described above.

The computer system 500 also can include software elements, shown as being currently located within the working memory 535, including an operating system 560, device drivers, executable libraries, and/or other code, such as one or more application programs 565, which may include computer programs provided by various embodiments, and/or may be designed to implement methods, and/or configure systems, provided by other embodiments, as described herein. Merely by way of example, one or more procedures described with respect to the methods discussed above, such as those described in relation to FIG. 5, might be implemented as code and/or instructions executable by a computer and/or a processor within a computer; in an aspect, then, such code and/or instructions can be used to configure and/or adapt a general purpose computer or other device to perform one or more operations in accordance with the described methods.

A set of these instructions and/or code may be stored on a non-transitory computer-readable storage medium, such as the storage device(s) 525 described above. In some cases, the storage medium might be incorporated within a computer system, such as computer system 500. In other embodiments, the storage medium might be separate from a computer system e.g., a removable medium, such as a compact disc, and/or provided in an installation package, such that the storage medium can be used to program, configure, and/or adapt a general-purpose computer with the instructions/code stored thereon. These instructions might take the form of executable code, which is executable by the computer system 500 and/or might take the form of source and/or installable code, which, upon compilation and/or installation on the computer system 500 e.g., using any of a variety of generally available compilers, installation programs, compression/decompression utilities, etc., then takes the form of executable code.

It will be apparent that substantial variations may be made in accordance with specific requirements. For example, customized hardware might also be used, and/or particular elements might be implemented in hardware, software including portable software, such as applets, etc., or both. Further, connection to other computing devices such as network input/output devices may be employed.

As mentioned above, in one aspect, some embodiments may employ a computer system such as the computer system 500 to perform methods in accordance with various embodiments of the technology. According to a set of embodiments, some or all of the operations of such methods are performed by the computer system 500 in response to processor 510 executing one or more sequences of one or more instructions, which might be incorporated into the operating system 560 and/or other code, such as an application program 565, contained in the working memory 535. Such instructions may be read into the working memory 535 from another computer-readable medium, such as one or more of the storage device(s) 525. Merely by way of example, execution of the sequences of instructions contained in the working memory 535 might cause the processor(s) 510 to perform one or more procedures of the methods described herein. Additionally, or alternatively, portions of the methods described herein may be executed through specialized hardware.

The terms “machine-readable medium” and “computer-readable medium,” as used herein, refer to any medium that participates in providing data that causes a machine to operate in a specific fashion. In an embodiment implemented using the computer system 500, various computer-readable media might be involved in providing instructions/code to processor(s) 510 for execution and/or might be used to store and/or carry such instructions/code. In many implementations, a computer-readable medium is a physical and/or tangible storage medium. Such a medium may take the form of a non-volatile media or volatile media. Non-volatile media include, for example, optical and/or magnetic disks, such as the storage device(s) 525. Volatile media include, without limitation, dynamic memory, such as the working memory 535.

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, or any other medium from which a computer can read instructions and/or code.

Various forms of computer-readable media may be involved in carrying one or more sequences of one or more instructions to the processor(s) 510 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 500.

The communications subsystem 530 and/or components thereof generally will receive signals, and the bus 505 then might carry the signals and/or the data, instructions, etc. carried by the signals to the working memory 535, from which the processor(s) 510 retrieves and executes the instructions. The instructions received by the working memory 535 may optionally be stored on a non-transitory storage device 525 either before or after execution by the processor(s) 510.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks. For example, executing instructions stored in the non-transitory computer-readable medium causes the processors to perform steps of methods and/or to implement features of components described herein.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered.

What is claimed is:

1. A system for torquing fasteners of a semiconductor manufacturing component, comprising:
a first driver comprising a bit and a bit tip;
a first toolhead connected to the bit of the first driver;
a first robotic arm connected to the first toolhead and configured to translate the first toolhead along an x-axis, a y-axis, and a z-axis;
one or more processors; and
a computer-readable medium comprising instructions that, when executed by the one or more processors, cause the one or more processors to perform operations to:
receive, by the system, a torque plan indicating a fastener pattern associated with the semiconductor manufacturing component;
determine, by the system and based at least in part on the torque plan, a respective position of each of a plurality of fasteners of the semiconductor manufacturing component;
determine, by the system and based at least in part on the torque plan, a respective torque associated with each of the plurality of fasteners;
cause, by the system, the robotic arm to translate such that the bit tip of the first driver iteratively engages with a fastener of the plurality of fasteners; and
cause, by the system, the first driver to rotate the bit of the first driver such that the fastener of the plurality of fasteners is tightened to the respective torque indicated by the torque plan.

2. The system of claim 1, wherein the toolhead is connected to a second driver and is configured to move the second driver independently of the first driver.

3. The system of claim 1, further comprising:
a second driver comprising a bit and a bit tip;
a second toolhead, connected to the bit of the second driver;
a second robotic arm connected to the second toolhead and configured to translate the second toolhead along the x-axis, the y-axis, and the z-axis, wherein the second driver, the second toolhead, and the second robotic arm are independently moveable; and
one or more controllers, configured to receive control signals from the one or more processors and cause the first and second robotic arms, the first and second toolheads, and the first and second drivers to perform one or more torquing operations.

4. The system of claim 3, wherein the first driver and the second driver tighten respective fasteners of the plurality of fasteners such that the respective torque for the fastener engaged by the first driver and the fastener engaged by the second driver is reached simultaneously.

5. The system of claim 1, wherein the bit tip of the first driver comprises a rounded portion and a pattern corresponding to at least a portion of the fastener.

6. The system of claim 1, wherein the semiconductor manufacturing device comprises a gas panel.

7. The system of claim 1, wherein the first robotic arm is configured to rotate the toolhead in one or more directions.

8. A method, comprising:
receiving, by a computing system, a torque plan indicating a fastener pattern associated with a semiconductor manufacturing component;
determining, by the computing system and based at least in part on the torque plan, a respective position of each of a plurality of fasteners of the semiconductor manufacturing component;
determining, by the computing system and based at least in part on the torque plan, a predetermined torque associated with each of the plurality of fasteners;
causing, by the computing system, a first robotic arm to translate such that a bit tip of a first driver engages with one or more fasteners of the plurality of fasteners; and
causing, by the computing system, the first driver to rotate a bit of the first driver such that a fastener of the plurality of fasteners is tightened to a predetermined torque.

9. The method of claim 8, further comprising:
determining, by the computing system, an actual torque of each of the one or more fasteners;
determining, by the computing system, whether the actual torque is different than the predetermined torque; and
in response to determining that the actual torque is different than the predetermined torque:
generating, by the computing system, and output for display indicating the actual torque.

10. The method of claim 8, further comprising:
generating, by the computing system, a build plan, the build plan comprising a record of each fastener and an associated actual torque, the record updated as the plurality of fasteners are tightened.

11. The method of claim 8, further comprising:
determining, by the computing system, a position of the semiconductor manufacturing component; and
causing, by the computing system, the first driver to be positioned in an initial position according to the torque plan.

12. The method of claim 11, wherein causing the first driver to be positioned in the initial position comprises moving one or more of the robotic arm and a toolhead that couples the first driver with the robotic arm.

13. The method of claim 8, wherein the computing system comprises one or more controllers configured to receive control signals from the computing system and cause the robotic arm and/or the first driver to perform torquing operations.

14. The method of claim 8, further comprising:
causing, by the system, a second robotic arm to translate such that a bit tip of a second driver engages a second fastener of the plurality of fasteners; and
causing, by the system, the second driver to rotate a bit of the second driver such that the second fastener of the plurality of fasteners is tightened to the predetermined torque.

15. The method of claim 14, wherein the first driver and the second driver tighten respective fasteners of the plurality of fasteners such that the predetermined torque is reached simultaneously.

16. A non-transitory computer-readable medium comprising instructions that, when executed by one or more processors, cause the one or more processors to perform operations comprising:
receiving, by a computing system, a torque plan indicating a fastener pattern associated with a semiconductor manufacturing component;
determining, by the computing system and based at least in part on the torque plan, a respective position of each of a plurality of fasteners of the semiconductor manufacturing component;
determining, by the computing system and based at least in part on the torque plan, a respective torque associated with each of the plurality of fasteners;
causing, by the computing system and according to the torque plan, a first robotic arm to translate such that a bit tip of a first driver engages with a fastener of the plurality of fasteners; and
causing, by the computing system and according to the torque plan, the first driver to rotate a bit of the first driver such that the fastener of the plurality of fasteners is tightened to a predetermined torque.

17. The non-transitory computer-readable medium of claim 16, wherein the torque plan is displayed in a user interface during operation of the computing system.

18. The non-transitory computer-readable medium of claim 17, wherein the user interface is configured to accept user input to modify the torque plan during operation.

19. The non-transitory computer-readable medium of claim 16, wherein the computing system causes a plurality of robotic arms, a plurality of toolheads, and a plurality of drivers to execute the torque plan.

20. The non-transitory computer-readable medium of claim 16, wherein each of the plurality of fasteners are tightened such that a seal of the semiconductor manufacturing component is uniformly compressed.
